(19) United States
(12) Patent Application Publication
(10) Pub. No.: US 2008/0013014 A1
(43) Pub. Date: Jan. 17, 2008

(54) Optical hybrid film and manufacture thereof

(75) Inventors: Wei-Bin Kuo, Hsinchu (TW); Hao-Jan Kuo, Hsinchu (TW); Cheng-Hsien Yang, Hsinchu (TW)

Correspondence Address: BRUCE H. TROXELL, SUITE 1404, 5205 LEESBURG PIKE, FALLS CHURCH, VA, 22041, US

(73) Assignee: OPTIVISION TECHNOLOGY INC.

(21) Appl. No.: 11/802,238

(22) Filed: May 21, 2007

(30) Foreign Application Priority Data
Jul. 12, 2006 (TW) 095145632

(51) Int. Cl. G02F 1/1335

(52) U.S. Cl. 349/64

(57) ABSTRACT

An optical hybrid film contains optically coupled light pipe diffuser and brightness enhancement optical elements combined in the form of one hybrid film on a transparent polymer film substrate for replacing both bottom diffuser film layer and bottom brightness enhancement film layer of a conventional optical film combination by one film of the hybrid film so as to improve the LCD brightness, extend a battery life and simplify a hybrid structure of every kind of optical film required for LCDs to save the production cost.

### BACKGROUND OF THE INVENTION

1. Field of the Invention

The present invention relates to an optical hybrid film, and more particularly to a backlight device for a liquid crystal display (LCD), allowing a greater proportion of light generated from a light generating element such as cold cathode fluorescent lamp (CCFL) to be output to a viewer outside the display.

2. Description of Related Art

Generally, a LCD requires a backlight device comprising a light guide plate and multilayer optical films used for extracting and directing light emitted from a substantially linear light source such as CCFL to produce a substantially planar output to a viewer outside the LCD.

The performance criteria for optical hybrid film include brightness, uniformity of brightness, size-down and cost-down of the backlight device. Brightness is very important as the higher the brightness the lower the battery power is required to achieve a specified level of brightness of the display and, hence the longer the battery life is. Battery life is very important in commercial applications such as notebooks and cellular phones. The uniformity of brightness in an LCD display is important to optimize the viewing of the user of the LCD. Cost is also very important as the LCD optical hybrid film is very subject to cost-down pressures from the LCD panel manufacturers.

Please refer to FIG. 1. A conventional LCD backlight device has a complex structure and typically comprises a CCFL 11, aback reflector layer 12, a light guide plate layer 13, first and second diffuser layers 14 and 17 and one or two of first and second brightness enhancement film (BEF) layers 15 and 16 (BEF available from 3M Inc.), and a layer of double brightness enhancement film (DBEF) can also be included in some cases.

The light guide plate layer 13 is used for converting the substantially linear light source CCFL 11 into a substantially planar output. To achieve this performance, the light guide plate layer 13 has light deflection elements built therein. To provide the light deflection elements, a surface of the light guide plate layer 13 can be coated with a material that scatters or reflects light, such as a resin containing light diffusing particles or a resin having a refractive index that is different from that of a substrate material of the light guide plate layer 13. The light guide plate layer 13 is generally manufactured by an ink jet printing method, a chemical etching process or injection molding disclosed in patents such as U.S. Pat. No. 6,027,221, U.S. Pat. No. 5,967,637, JP 10-052839, U.S. Pat. No. 5,618,096 and U.S. Pat No. 6,123,431. Considerable effort and expense are required to design and manufacture the light guide plate layer 13 to give optimal conversion of linear light from the CCFL 11 to planar light to the outside. The effectiveness of the process mentioned above has an enormous effect on the brightness of the planar light output from the backlight device and, hence, the brightness of the LCD.

Please refer to FIG. 1 again. In the conventional LCD backlight device, the planar light output emerging from the surface of the light guide plate layer 13 is at around 90 degrees to the linear direction of light from the CCFL 11. The light then enters the first diffuser layer 14 with a symmetrical half angle of view (AoV) of 20 degrees. Thereafter, the light enters a first BEF 15 such as BEFII or BEFIII from 3Ml or OP2 from Optivision Inc. Next, the light enters a second BEF layer 16 and then, the light enters the second diffuser layer 17 with a symmetrical half AoV 10 degrees before finally emerging outside the LCD backlight device as a planar output. The purpose of all the optical film layers mentioned above is to optimize the brightness of the display. The diffuser layers 14 and 17 and the BEF layers 15 and 16 are manufactured using roll-to-roll polymer coating and/or embossing processes.

Additionally, it is well known that the LCD industry is growing at around 30% per annum; such a high growth rate requires tremendous input of raw materials. For example, most of the optical films currently used in the LCD backlight device are based on polyethylene terapthalate (PET) film substrate and demand for such films is currently in excess of 100 million square metres per annum. The raw materials for manufacture of the PET substrate are derived from petroleum and their supplies are limited and dependent on crude oil production and price of oil. For sustainable and environmentally friendly growth of the LCD industry, it is important that technologies are available which not only enable savings in the manufacturing costs but also reduce the net amount of raw materials such as plastics used in the manufacture of LCDs.

Furthermore, a significant problem with the aforementioned type of the LCD backlight device is that a considerable proportion of the planar light emergent from the light guide plate and entering the layered sheets of optical films (BEFs, DBEF and diffusers) is not emitted to the outside by the layered structure, but instead is wave guided away laterally by virtue of total internal reflection (TIR) within the film sheets. As FIG. 2 shows, in such structure, when light L1 enters the optical films 21 and 22, a major proportion thereof light L2 may be guided laterally such that light L3 emergent towards the viewer may be only 20% of light L1; see T. Tsutsui, E. Aminaka, C. P. Lin, D.-U Kim, Phil, Trans. R. Soc. London A, 1997, 355, 801. Total internal reflection is the reflection of light from interface between a medium with index of refraction n₁ and a medium with index of refraction n₂, where n₂<n₁, when the light incident on the interface makes an angle of θ>θ_{c}=sin⁻¹ (n₂/n₁) to the normal of the interface, where θ_{c} is the critical angle.

There are various proposals and products in the LCD industry for maximizing performance of the LCD backlight device. These include optical elements in the layered structure of the display, the optical elements shape light output from the CCFL to enhance the brightness perceived by the viewer, i.e. collimate the light or to redirect the emitted light into a more desirable viewing cone, such products include prismatic optical films manufactured and marketed by companies such as 3M Inc., LG or SKC. However, the optical elements do not significantly increase the net amount of light generated by the CCFL coupled to the outside; i.e. the optical elements mentioned above do not reduce the amount of light being wave guided laterally and lost due to total internal reflection (TIR).

Therefore, the performance of the LCD backlight assembly can be improved both in terms of costs saving in raw materials and brightness by reducing the number of layers of optical film sheets. This gives cost reduction and reduction in raw material usage due to the fact that one less sheet of optical film is used and gives brightness increase because reducing the number of optical film sheets present in the back light assembly reduces the loss of light by wave guiding within the optical film sheets, since the higher the total number of sheets, the higher the loss of light due to TIR and lateral wave guiding.

Additionally, the diffusers currently used in the LCD backlight are disperse particle diffusers and are manufactured by coating PET film with a photopolymer coating containing dispersed particles such as inorganic oxides such as titanium oxide which are supplied by companies such as SKC (Korea) and Physical Optics Corporation (USA). Each such diffuser layer 30, as FIG. 3 shows, is provided with a surface structure 31 and particles 32 therein. Light L1 entering the diffuser layer 30 is subject to refraction in forward propagation is separated to three kinds of light, i.e. light L2 subject to refraction, refection and diffusion in forward propagation, light L3 being a loss through wave guiding in lateral propagation and light L4 being a loss through back scatter. The back scatter takes place when a ray of light hits a particle head-on and is bounced back. Eventually, some of the light bouncing back is reflected forward again by a back reflector. However, in these types of cycles of backscatter and once more forward reflection, a proportion of light L4 is again lost by the lateral wave guiding as explained above.

It is known to those skilled in the art that ray tracing software modeling readily shows that although BEFs and a reflector are used in the backlight device, it is not possible to recycle and forward to the output surface all the light lost through back scatter since some of the light is lost through lateral wave guiding.

### SUMMARY OF THE INVENTION

For improving a hybrid structure of every kind of optical film to increase LCD brightness, the present invention is proposed.

The main object of the present invention is to provide an optical hybridfilm, capable of being used in LCD backlight structures so as to improve LCD brightness and extend a battery life.

Another object of the present invention is to provide an optical hybrid film, capable of being used in LCD backlight structures so as to simplify a hybrid structure of every kind of optical film required for LCDs to save the production cost.

For attaining to the objects mentioned above, the present invention proposes an optical hybrid film; it contains optically coupled light pipe diffuser and brightness enhancement optical elements combined in the form of one hybrid film on a transparent polymer film substrate such as PET film, polycarbonate film or TAC film for replacing both bottom diffuser film layer and bottom brightness enhancement film layer of a conventional optical film combination by one film of the hybrid film so as to improve the LCD brightness, extend a battery life and simplify a hybrid structure of every kind of optical film required for LCDs to save the production cost.

The present invention also proposes a method for manufacturing an optical hybrid film; it comprises the following steps:
Step 1: coating one face of a transparent polymer film substrate with optivision proprietary photopolymer resin to give a light pipe diffuser film; and
Step 2: reversing the transparent polymer substrate and forming a prismatic brightness enhancement film on a reverse side thereof.

Whereby, the both faces of the transparent polymer substrate are respectively combined with the light pipe diffuser film and the prismatic brightness enhancement film to form the optical hybrid film; it can be used in a LCD structure to improve the LCD brightness, extend a battery life and simplify a hybrid structure of every kind of optical film required for LCDs to save the production cost.

### BRIEF DESCRIPTION OF THE DRAWINGS

The present invention can be more fully understood by reference to the following description and accompanying drawings, in which:

FIG. 1 is a schematic view of a conventional LCD backlight device;

FIG. 2 is schematic view of progression directions of light entering a conventional optical film;

FIG. 3 is schematic view of progression directions of light entering a conventional diffuser film;

FIG. 4 is a schematic view, showing an optical hybrid film structure of a preferred embodiment according to the present invention;

FIG, 5 is an image of a cross sectional view of a light tube diffuser film;

FIG. 6 is a comparison table of four kinds of backlight combinations; and

FIG. 7 is a flow chart of a manufacture of a hybrid film of the present invention.

### DETAILED DESCRIPTION OF THE PREFERRED EMBODIMENTS

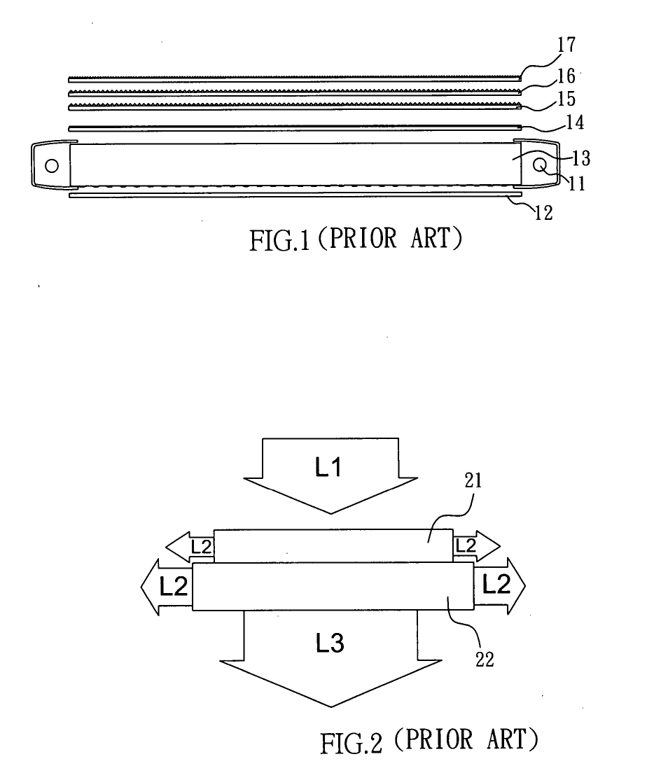

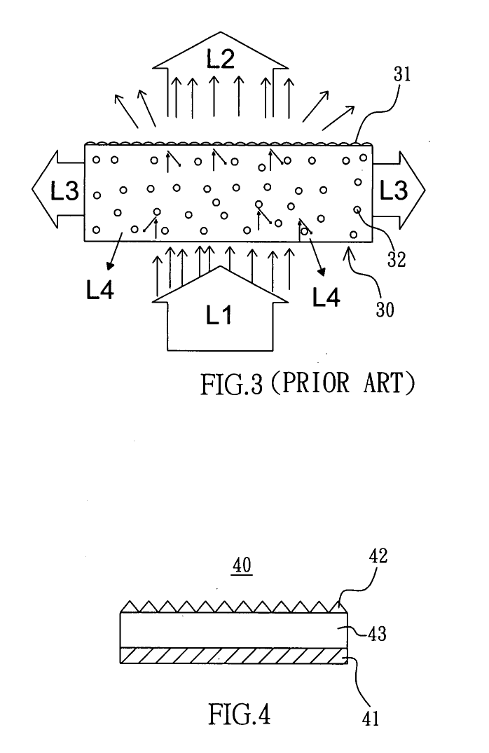

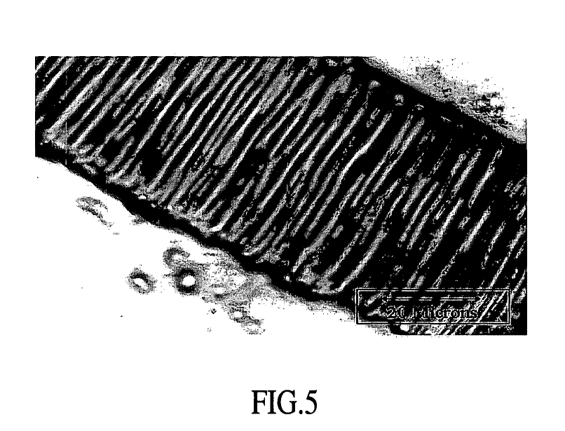

Please refer to FIGS. 4 and 5. The present invention proposes an optical hybrid film 40 used in a device such as the LCD backlight shown in FIG. 1 to replace the first and the second diffuser film layers 14 and 17 and the first and the second brightness enhancement film layers 15 and 16 thereof. The optical hybrid film 40 comprises an optically coupled light pipe diffuser 41 and prismatic brightness enhancement film 42 respectively combined on two sides of a transparent polymer film substrate 43 to form a hybrid film, as FIG. 4 shows.

A light tube diffuser film 41, as FIG. 5 shows, is a volume diffuser comprising vertical columns called light pillars or light pipes of micrometer dimension extending from one edge to another edge of the film 41. The characteristic of the light pipe material is that the refractive index of the material comprising the light pipes n1 greater than the refractive index n2 of the material outside the light pipes. The number or the density of the light pipes across the plane of the film 41 can be manipulated to control the optical properties of the film 41 such as the AoV (angle of view). Thus, as the density of the light pipes increases so does diffusion i.e. the AoV increases as the number of the light pipes across the cross-section of the film 41 increases because there are then more light pipes to diffuse the light. Furthermore, since there are an immense number of closely packed vertical light pipes across the plane of the light pipe diffuser film, there is an immense number of refractive index alternation such that a ray of light traveling laterally through the film 41 by wave guiding as described above, passes across the immense number of refractive index changes such as n1, n2, n1, n2, n1, n2, n1, n2 . . . n1, n2. It is stressed again that the light pipe diffuse is a volume diffuser, i.e. there are not particles nor is there any texture on the surface of the light pipe diffuser film 41. The diffusion takes place due to the light pipes within the body of the diffuser film 41 since these light pipes function rather like lenses.

It can be shown by optical modeling software packages based on ray tracing that such a ray of light entering the light pipe diffuser film 41 from the direction of the light guide plate and being wave guided laterally as described above will experience “straightening”, i.e. multiple refractions such that its direction is turned towards the outside planar surface of the optical hybrid film. The result is “light gathering” of the laterally wave guided light is normally lost and it's redirected towards the viewer resulting in increased brightness due to the increase in net light output being coupled from the CCFL to the outside. Such light pillar or light pipe diffusers are available commercially from companies such as Tomoegawa Paper Company Limited (Japan) or Optivision Technology Inc. (Taiwan).

According to a preferred embodiment of the present invention, the prismatic BEF film 42 has apex angle in the range 70 degrees to 95 degrees, the transparent polymer film substrate 43 is an optical adhesive. The light pipe diffuser film 41 is coupled to the prismatic BEF film 42 using the optical adhesive which has high transparency and its refractive index matches there fractive index of the diffuser film 41 and the prismatic BEF film 42. Even if there fractive indices of the light pipe diffuser 41 and the prismatic BEF film 42 differ from the optical adhesive, the adhesive should have a refractive index that is between the refractive indices of the two films. Accordingly, the refractive index matching means the minimization of the difference between the refractive indices of the two films in order to minimize the amount of total internal reflection within the substrate and thus reduce the amount of wave guiding occurring in the substrate and leading to sideways (lateral) loss of light. Thus, refractive index matching means maximization of the amount transmitted from one medium to the next via minimization of reflection processes and, hence, increase in the amount of light coupled from the CCFL to the outside of the backlight. Thus, the LCD will be brighter or consume less power to produce the same amount of brightness. In the embodiment, the optical hybrid film 40 is used to produce the same amount of brightness for less power, the battery life of the equipment incorporating such a device, for example a notebook computer of a cellular phone, will be longer.

It will be appreciated by those skilled in the art that the term “Optically coupled” as used here means that the refractive indices of the two surfaces are closely matched and the adhesive used to join them has a refractive index which is equal to or falls between the values of the two film surfaces to be joined. The better the matching of the refractive indices is, the higher the effectiveness of the optical coupling is. Preferably, the indices should not differ by more than 10%. Also, the optical adhesive must have high transmission to visible light, i.e. in the wavelength range 400 nm (Nanometer) to 700 nm such that the high transmission is comparable to the optical grade PET substrate used to manufacture the diffuser and the prismatic BER film; the PET films normally have optical light transmission>86%. The optical adhesives are available commercially from companies such as 3M Inc. (USA) or Adhesive Research Laboratories Inc. (USA).

In another preferred embodiment of the present invention, a light pipe diffuser with a symmetrical half AoV in the range 10 to 20 degrees is coupled to a BEF film comprising an array of prisms of apex angles 90 degrees, prism pitch 50 microns and prism height 25 microns by coating the PET side of the light pipe diffuser with a high optical transmission photopolymer coating and creating the 90 degrees prismatic pattern by embossing using an appropriately designed nickel shim or embossing roller and UV curing the photopolymer coating. This type of embossing process is known to those skilled in the art and has been described in Taiwan Patent No. 1234514 titled as “holographic image contract film and manufacture thereof”. However, the result is a new type of optical film configuration that comprises the PET film in the middle and the light pipe diffuser film on one side and the prismatic film on the other side.

### EXAMPLE 1

A light pipe diffuser film with a symmetrical half AoV of 20 degrees is coupled to a BEF film comprising an array of prisms of apex angles 90 degrees, prism pitch 50 microns and prism height 25 microns by coating the PET side of the light pipe diffuser with a high optical transmission photopolymer coating and creating the 90 degrees prismatic pattern by embossing using an appropriately designed metallic shim or embossing roller and UV curing the photopolymer coating to give a optical hybrid film HF1 as FIG. 4 shows; it comprises a light pipe film on one side of the PET and BEF prism film on the other side of the PET.

### EXAMPLE 2

A light pipe film of symmetrical half AoV 20 degrees is bonded to a 3M film BEF III by using an Adhesive Research Inc. adhesive film AR8154 which has a refractive index of about 1.5 to give an optical hybrid film HF2.

### EXAMPLE 3

A light pipe film of symmetrical half AoV 20 degrees is bonded to a BEF made by Optivision Corporation Inc. by using an Adhesive Research Inc. adhesive film AR8154 which has a refractive index of about 1.5 to give an optical hybrid film HF3.

A conventional 15 inch diagonal LCD backlight device as shown in FIG. 1 is assembled using currently used conventional surface coating diffusers commercially available from companies such as SKC (Korea) and 3M BEF III. The brightness of a conventional LCD backlight is measured using Topcon (designation of equipment).

A light pipe film of symmetrical half AoV 5 to 30 degrees can be adopted according to the present invention.

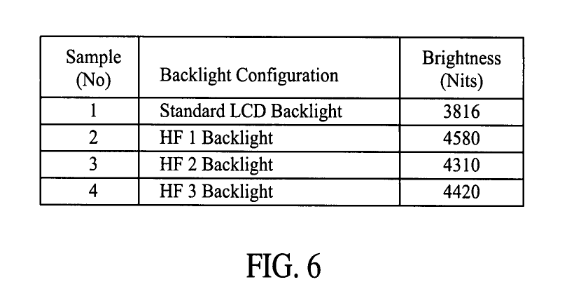

Please refer to FIG. 6. All the backlights of the hybrid films of the examples described above according to the present invention are tested by measuring the brightness of the backlight and comparing with the conventional backlight; it shows that the hybrid film of the present invention allow a backlight to have a better brightness than the combination of conventional diffuser and BEF films.

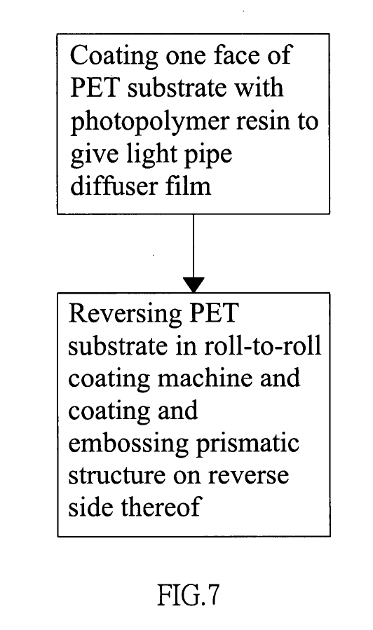

Please refer to FIG. 7. The present invention proposes a method for manufacturing an optical hybrid film comprising the follow steps:
Step 1: coating one face of a polyethylene terapthalate (PET), polycarbonate film or TAC film substrate with Optivision proprietary photopolymer resin OT1-LP-X10 to give a light pipe diffuser film; and
Step 2: reversing the PET substrate in a roll-to-roll coating machine and coating and embossing a prismatic structure on the reverse side thereof.

Whereby, the both faces of the transparent polymer substrate are respectively combined with the light pipe diffuser film and the prismatic brightness enhancement film to form the optical hybrid film.

The optical hybrid film of the present invention can be used in a LCD structure to improve the LCD brightness, extend a battery life and simplify a hybrid structure of every kind of optical film required for LCDs to save the production cost.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical hybrid film, comprising optically coupled light pipe diffuser film an brightness enhancement film respectively combined on two sides of a transparent polymer film substrate; the substrate being chosen from at least one film selected from a group consisting of a polyethylene terapthalate, polycarbonate film and TAC film substrate; whereby, the hybrid film is adapted to replace diffuser films and brightness enhancement films in a conventional optical film combination.

2. The optical hybrid film according to claim 1, wherein the transparent polymer film substrate is an adhesive.

3. The optical hybrid film according to claim 1, wherein the light pipe diffuser film has a symmetrical angle of vision (AoV) of 30 degrees.

4. The optical hybrid film according to claim 1, wherein the light pipe diffuser film has a symmetrical angle of vision (AoV) of 25 degrees.

5. The optical hybrid film according to claim 1, wherein the light pipe diffuser film has a symmetrical angle of vision (AoV) of 20 degrees.

6. The optical hybrid film according to claim 1, wherein the light pipe diffuser film has a symmetrical angle of vision (AoV) of 15 degrees.

7. The optical hybrid film according to claim 1, wherein the light pipe diffuser film has a symmetrical angle of vision (AoV) of 10 degrees.

8. The optical hybrid film according to claim 1, wherein the light pipe diffuser film has a symmetrical angle of vision (AoV) of 5 degrees.

9. The optical hybrid film according to claim 2, wherein the light pipe diffuser film has a symmetrical angle of vision (AoV) of 20 degrees.

10. The optical hybrid film according to claim 2, wherein the light pipe diffuser film has a symmetrical angle of vision (AoV) of 10 degrees.

11. The optical hybrid film according to claim 1, wherein the brightness enhancement film is a prismatic brightness enhancement film.

12. The optical hybrid film according to claim 2, wherein the brightness enhancement film is a prismatic brightness enhancement film.

13. The optical hybrid film according to claim 4, wherein the brightness enhancement film is a prismatic brightness enhancement film.

14. The optical hybrid film according to claim 5, wherein the brightness enhancement film is a prismatic brightness enhancement film.

15. The optical hybrid film according to claim 6, wherein the brightness enhancement film is a prismatic brightness enhancement film.

16. The optical hybrid film according to claim 7, wherein the brightness enhancement film is a prismatic brightness enhancement film.

17. The optical hybrid film according to claim 9, wherein the brightness enhancement film is a prismatic brightness enhancement film.

18. The optical hybrid film according to claim 10, wherein the brightness enhancement film is a prismatic brightness enhancement film.

19. A method for manufacturing an optical hybrid film of claim 1, comprising the following steps:
(1) coating one face of a transparent polymer substrate with a photopolymer resin to give a light pipe diffuser film; the substrate being chosen from at least one film selected from a group consisting of a polyethylene terapthalate (PET), polycarbonate film or TAC film substrate; and
(2) reversing the transparent polymer substrate and forming a prismatic brightness enhancement film on a reverse side thereof;
whereby, the both faces of the transparent polymer substrate are respectively combined with the light pipe diffuser film and the prismatic brightness enhancement film to form the optical hybrid film.

20. The method according to claim 19, wherein Step (2) further comprises reversing the transparent polymer substrate in a roll-to-roll coating machine and coating and embossing a prismatic structure on a reverse side thereof.
